(19) United States
(12) Patent Application Publication
(10) Pub. No.: US 2002/0144408 A1
(43) Pub. Date: Oct. 10, 2002

(54) Blade guard apparatus for brush cutter

(76) Inventor: Kyu-Man Cho, Kwangju-City (KR)

Correspondence Address: BURNS DOANE SWECKER & MATHIS L L P, POST OFFICE BOX 1404, ALEXANDRIA, VA, 22313-1404, US

(21) Appl. No.: 10/073,058

(22) Filed: Feb. 12, 2002

Related U.S. Application Data
(63) Continuation of application No. 09/855,702, filed on May 16, 2001.

(30) Foreign Application Priority Data
Apr. 10, 2001 (KR) 10126/2001

(51) Int. Cl. B26B 29/00

(52) U.S. Cl. 30/286; 30/276

(57) ABSTRACT

A blade guard apparatus for a brush cutter comprises a blade guard member which prevents solid objects such as gravels or thick sticks from approaching a blade in use to protect the blade and holds the blade to prevent an accident if released from the brush cutter. The blade guard apparatus comprises a blade guard member which can prevent damage of a blade by solid objects such as gravels or thick sticks and an unexpected injury of a human body due to release of the blade and allow cutting operation even on an irregular working plane while maintaining a horizontal status, and also a bracket in a certain shape which collects the cut weeds along the progressing direction of the blade so as not to be spread and efficiently interrupts the cut weeds or objects from being splashed to the user. The blade guard apparatus for the brush cutter which includes a guide pipe 10 configured for allowing a user to work in a standing position, a rotary axis 12 powered from a power unit for being rotated and a blade 13 fastened to the rotary axis 12 with nuts 15 for cutting weeds, the blade guard apparatus comprises a blade guard member 20 positioned under the blade 13 for protecting the blade 13 from objects from the ground and guiding a cutting operation; a bracket 30 with one side coupled to the blade guard member 20 at the lower part and the other side coupled to the guide pipe 10 for interrupting the cut weeds from being splashed to the user; and a number of guide perforations 33 formed in the bracket 30 for allowing height adjustment of the bracket 30 according to the brush cutter type. The blade guard member includes beads 23 extruded from a central portion of the blade guard member 20 for preventing release of the blade and friction between the blade 13 and the blade guard member 20; and a number of guide grooves 21 and 22 formed at both sides and the front side of the blade guard member 20 for guiding weeds to be cut to the blade 13.

### BACKGROUND OF THE INVENTION

1. Field of the Invention

The present invention relates to a blade guard apparatus for a brush cutter, in particular, which comprises a blade guard member for preventing solid objects such as gravels or thick sticks from approaching a blade in use to protect the blade while holding the blade to prevent an accident if released from the brush cutter.

2. Description of the Related Art

In general, in order to cut weeds or bush by using a brush cutter as shown in FIG. 5, a throttle vale 6 is pulled after starting an engine 5, then a blade 2 is rotated to cut the weeds or bush, in which a working rod 1a is connected to the blade 2 at the upper part thereof and has a guard cover 3a for preventing weeds cut by the rotation of the blade 2 in mowing from being splashed to a user.

However, in such a guard cover 3a installed in the brush cutter of the related art, the guard cover 3a for preventing the splash of the cut weeds or dirt to the user is closed only toward the user, by which the cut weeds are spread through an opened portion of the guard cover 3a so that the cut weeds are cut again thereby lowering the efficiency of the operation.

Also, the blade 2 is exposed through the opened portion of the guard cover 3a in operation, by which an accident may take place when a person such as a child unconsciously approach the brush cutter.

Further, the blade 2 is integral with a rotary axis. So, when a cutting portion collides or contacts against a sold object such as a stone or an iron body, a portion of the blade 2 can be impacted due to a progressing force of the blade 2 and a resisting force of the solid object.

Then, the blade 2 can be bent or broken from the collision into the solid object and the user may drop the working rod 1a under the impact of the collision thereby probably causing a secondary accident. Further, impact can be applied to a shaft for transmitting power from the engine to degrade the performance of the brush cutter.

### SUMMARY OF THE INVENTION

The present invention is proposed to solve the foregoing problems and it is therefore an object of the invention to provide a blade guard apparatus for a brush cutter comprising a blade guard member which can prevent damage of a blade by solid objects such as gravels or thick sticks and an unexpected injury of a human body due to release of the blade and allow cutting operation even on an irregular working plane while maintaining a horizontal status, and also a bracket in a certain shape which collects the cut weeds along the progressing direction of the blade so as not to be spread and efficiently interrupts the cut weeds or objects from being splashed to the user.

According to an embodiment of the invention to obtain the foregoing object, it is provided a blade guard apparatus for a brush cutter which includes a guide pipe configured for allowing a user to work in a standing position, a rotary axis powered from a power unit for being rotated and a blade fastened to the rotary axis with nuts for cutting weeds, the blade guard apparatus comprising: a blade guard member positioned under the blade for protecting the blade from objects from the ground and guiding a cutting operation; a bracket with one side coupled to the blade guard member at the lower part and the other side coupled to the guide pipe for interrupting the cut weeds from being splashed to the user; and a number of guide perforations formed in the bracket for allowing height adjustment of the bracket according to the brush cutter type.

Here, it is preferred that the blade guard member includes beads extruded from a central portion of the blade guard member for preventing release of the blade and friction between the blade and the blade guard member; and a number of guide grooves 21 and 22 formed at both sides and the front side of the blade guard member 20 for guiding weeds to be cut to the blade.

### BRIEF DESCRIPTION OF THE DRAWINGS

FIG. 1 is a perspective view for showing a brush cutter of the invention;

FIG. 2 is a sectional view through A-A line of FIG. 1;

FIG. 3 is a partial sectional view for showing a brush cutter of the invention;

FIG. 4A is a front elevation view for showing a bracket of the invention;

FIG. 4B is a side elevation view of FIG. 4A; and

FIG. 5 is a perspective view for showing a brush cutter of the related art.

### DETAILED DESCRIPTION OF THE PREFERRED EMBODIMENT

Hereinafter it will described in detail about a blade guard member for brush cutter of the invention in reference to the appended drawings.

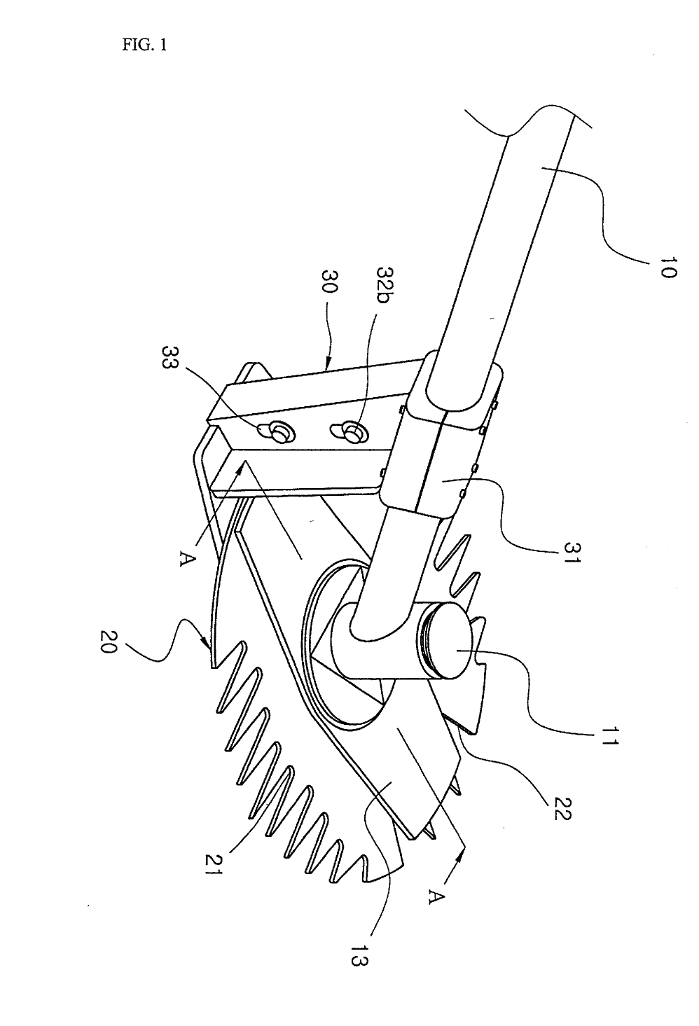

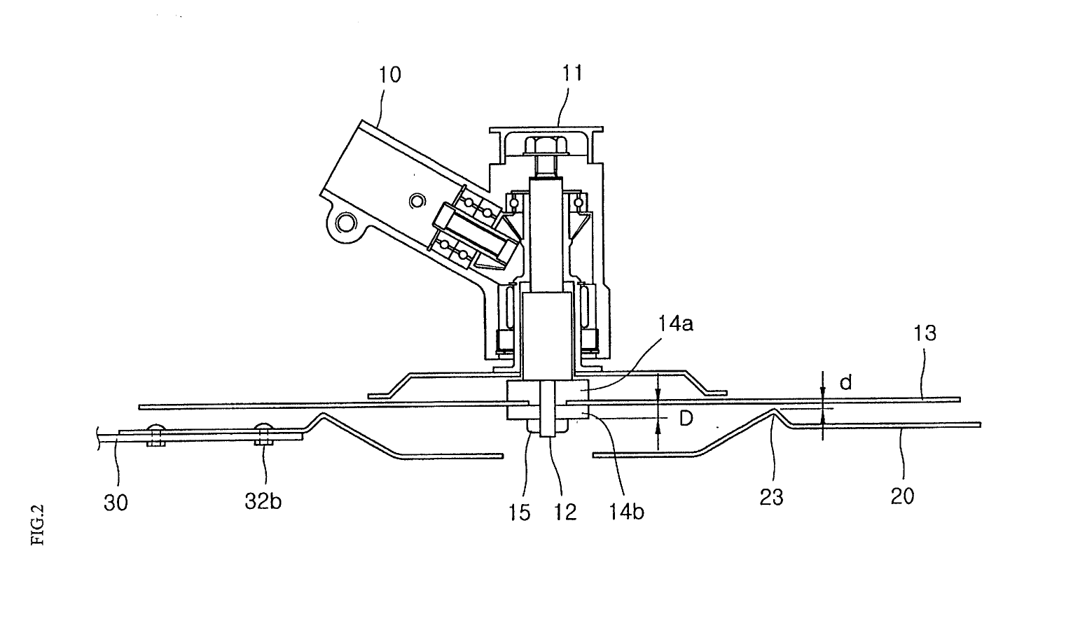

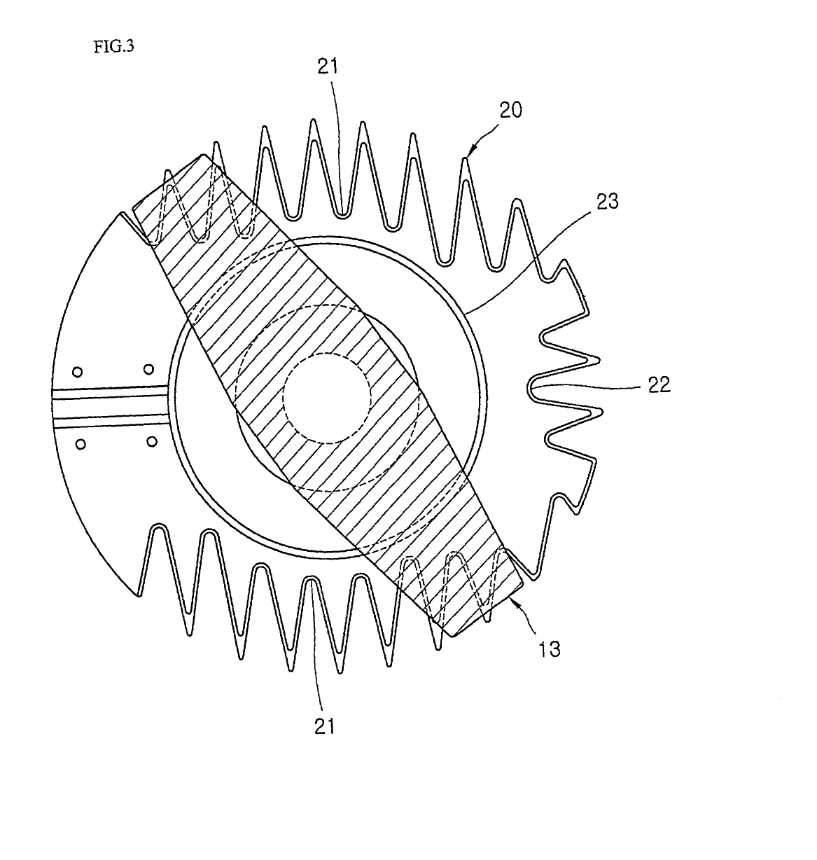

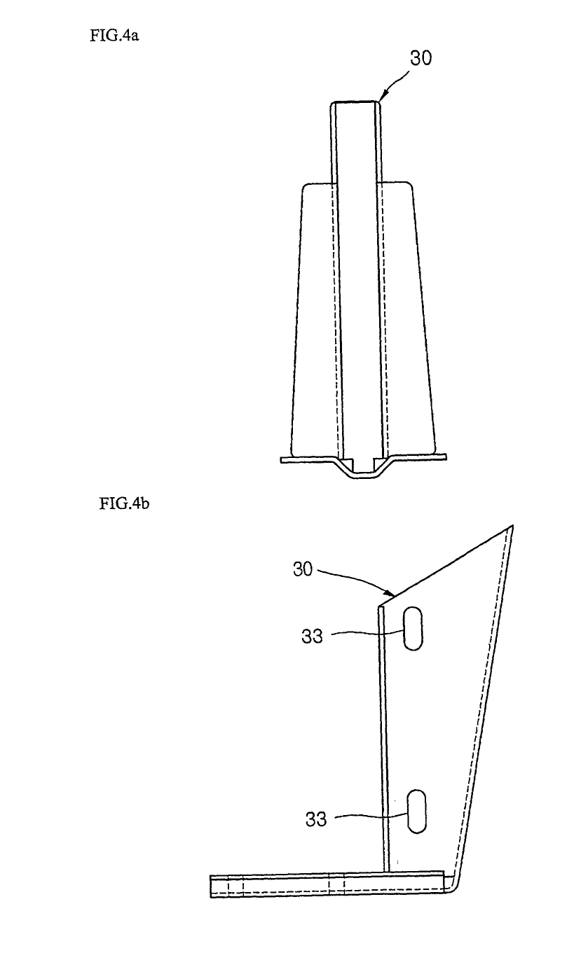

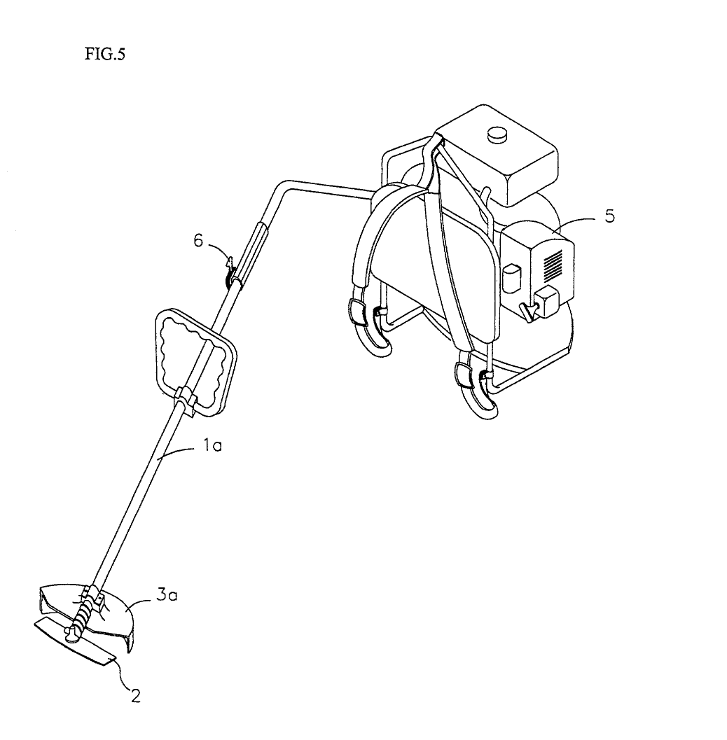

FIG. 1 is a perspective view for showing a brush cutter of the invention, FIG. 2 is a sectional view through A-A line of FIG. 1, FIG. 3 is a partial sectional view for showing a brush cutter of the invention, FIG. 4A is a front elevation view for showing a bracket of the invention, and FIG. 4B is a side elevation view of FIG. 4A.

Referring to the appended drawings, the brush cutter of the invention comprises a guide pipe or a working rod 10 provided in such a length that a user can work as standing, a rotary axis 12 arranged within an axis cap 11 connected to the working rod 10 for being powered from power generating means to be rotated, a blade 13 fastened to the rotary axis 12 in the bottom by washers 14a and 14b and nuts 15 for cutting weeds, and a blade guard member 20 placed in the lower part of the blade 13 for protecting the blade 13 from solid objects on the ground and guiding for mowing operation.

The blade guard member 20 includes beads 23 extruded in a central portion with a certain interval for preventing the blade 13 from being released and for preventing friction between the blade 13 and the blade guard member 20, and a number of guide grooves 21 and 22 formed at both sides and the front part of the blade guard member 20 for guiding weeds to be cut to the blade 13. The the blade guard member 20 has diameter larger than that of the blade 13 and interrupts that stones or iron objects with at least a certain size may approach the blade 13 to protect the blade 13.

Here, the distances from the blade 13 to the beads 23 and the lower washer 14b preferably have the relation of d=¼˜½D, wherein d is the distance from the blade bottom to the bead top and D is the distance from the blade bottom to the lower washer. Thus, the blade 13 is interrupted by the beads 23 even if the nut 15 for fixing the blade 13 is released due to external impact to prevent danger.

Also, the beads 23 are formed with an interval from the blade 13 and the blade guard member 20 body, which functions to prevent friction with the blade 13 when the blade guard member 20 body is impacted from the ground.

The side guide grooves 21 in the number of guide grooves 21 and 22 are shaped as a comb with grooves to the periphery of the beads 23 for erecting and guiding bound or fell weeds in order to the blade 13. The blade 13 and the side guide grooves 21 are shaped as a scissor to cut the weeds in rotation of the blades 13.

Also, the front guide grooves 22 have grooves shallower than those of the side guide grooves 21 for cutting twigs of bush.

The bottom of the blade guard member 20 and the bottom and top of a bracket coupling member 31 fixed to the working rod 10 are fastened to a bracket 30 by bolts 32a and 32b and nuts. The bracket 30 effectively interrupts the cut weeds and objects from being splashed to the user at work, prevents the cut weeds from being spread, and collects the weeds cut through the progressing direction of the blade for making the finish thereof easy.

Also, an O-shaped guide perforations 33 are formed at the upper and lower parts of the bracket 30 so that the bracket 30 can be adjusted in the height according to the position of fixing the bracket coupling member 31 to the guide perforations 33 of the bracket 30 with the bolts 32b and the nuts.

Describing the operation of the invention constructed as above, when a throttle valve is drawn after an engine (not shown) is started for using the brush cutter, the blade 13 cuts the weeds or bush as rotating.

The cutting is performed in an uneven part of the ground in cutting the weeds, in which the brush cutter can be maintained horizontal by the blade guard member 20 provided in the under the blade 13.

Here, the weeds are cut along the side guide grooves 21 formed at the both sides of the blade guard member 20, and the twigs of bush are effectively cut along the front guide grooves 22 formed in the front part.

Also, the number of guide grooves 21 and 22 are formed in such a certain width that the stones or iron objects with a certain size are interrupted from intruding into the blade 13 to protect the blade 13.

The blade released due to an unexpected accident during the cutting work as above is interrupted by the beads 23 formed in the central portion of the blade guard member 20 to protect an accident.

Also, the bracket 30 coupled to the blade guard member 20 and the guide pipe can interrupt the cut weeds or objects from being splashed to the user so that the mowing operation can be performed more safely by using the brush cutter according to the invention.

According to the invention as described hereinbefore, the blade guard member is provided to the brush cutter to interrupt the solid objects such as the stones or the iron objects from intruding into the blade thereby to prevent damage of the blade. Also the blade guard member can interrupt release of the blade due to impact with the objects in the unexpected accident and the secondary accident due to dropping the working rod thereby to enhance working reliability of the brush cutter.

Also, the brush cutter can be horizontally operated due to the blade guard member even on the uneven working ground, and can be flexibly operated according to the kind of the weeds or bush by the guide grooves formed in the blade guard member.

Further, due to the bracket of a certain shape, the cut weeds are collected along the progressing direction of the blade without being spread and the cut weeds or objects can be efficiently interrupted from being splashed to the user.

What is claimed is:

1. A blade guard apparatus for a brush cutter which includes a guide pipe configured for allowing a user to work in a standing position, a rotary axis powered from a power unit for being rotated and a blade fastened to the rotary axis with nuts for cutting weeds, said blade guard apparatus comprising:
a blade guard member positioned under the blade for protecting the blade from objects from the ground and guiding a cutting operation;
a bracket with one side coupled to said blade guard member at the lower part and the other side coupled to the guide pipe for interrupting the cut weeds from being splashed to the user; and
a number of guide perforations formed in said bracket for allowing height adjustment of said bracket according to the brush cutter type.

2. A blade guard apparatus for a brush cutter according to claim 1, wherein said blade guard member includes:
beads extruded from a central portion of said blade guard member for preventing release of the blade and friction between the blade and the blade guard member; and
a number of guide grooves and formed at both sides and the front side of said blade guard member for guiding weeds to be cut to the blade.
